(19) United States
(12) Patent Application Publication
(10) Pub. No.: US 2008/0301453 A1
(43) Pub. Date: Dec. 4, 2008

(54) OFFICE MACHINE HAVING IDENTIFICATION UNIT AND DOCUMENT MANAGEMENT SYSTEM INCLUDING SUCH OFFICE MACHINE

(75) Inventors: Yi-Yuan Shih, Taoyuan Hsien (TW); Chen-Chi Chang, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: TECO IMAGE SYSTEMS CO., LTD, Taoyuan Hsien (TW)

(21) Appl. No.: 11/940,239

(22) Filed: Nov. 14, 2007

(30) Foreign Application Priority Data
Jun. 1, 2007 (TW) 096119806

(51) Int. Cl. G06F 7/04; H04L 9/00

(52) U.S. Cl. 713/176; 713/168

(57) ABSTRACT

The present invention relates to an office machine having an identity verification unit and a document management system including such an office machine. The office machine includes a processor and an identity verification unit. The processor is used for controlling operations of the office machine. The identity verification unit is included in the processor for verifying identity information of a user when an electronic document sent from the user is received by the office machine. The electronic document is verified according to an asymmetric cryptosystem, thereby ensuring security and user authenticity of the electronic document.

### FIELD OF THE INVENTION

The present invention relates to an office machine, and more particularly to an office machine having an identity verification unit and a document management system including such an office machine.

### BACKGROUND OF THE INVENTION

With increasing industrial development, digitalized office technologies have experienced great growth and are now rapidly gaining in popularity. In other words, a diversity of office machines such as copy machines, printers, fax machines, scanners and/or personal computers are utilized to achieve various purposes. As a consequence, the working efficiency is enhanced and the document management is more convenient. The diverse office machines, however, occupy lots of space. As the number of the office machines is increased, more operative space is occupied. For saving the working space, a multifunction peripheral having multiple functions in one structural unit is developed. Therefore, the processing capability of the multifunction peripheral is increased and the operative space thereof is reduced.

Referring to FIG. 1, a conventional document management system for use with an office machine is schematically illustrated. The conventional document management system 1 principally a multifunction peripheral 11, a file transfer protocol server (Ftp server) 12, an e-mail server 13, a router 14, a first personal computer PC1 and a second personal computer PC2, which are communicated with each other through a local area network (LAN) 10. The local area network 10 is communicated with the Internet 16 through the router 14.

Through operation of the first personal computer PC1, the electronic document 15 to be printed is transmitted to the multifunction peripheral 11. Likewise, through operation of the second personal computer PC2, the electronic document 15 to be printed may also be transmitted to the multifunction peripheral 11. No matter who are the operators, the electronic document 15 will be printed out by the multifunction peripheral 11 as long as the personal computer is linked to the local area network 10. In a case that the electronic document 15 is confidential and the operator is an outsider of the company, the contents of the electronic document 15 are revealed without being conscious of the company.

Moreover, by means of the multifunction peripheral 11, an original document may be scanned into a photographic electronic document. The photographic electronic image may be sent to the receivers beyond the company over the Internet by e-mail. If no proper document management is adopted, the secret of the company will be easily revealed. In addition to e-mail, the photographic electronic document may be transmitted to the file transfer protocol server 12. The user having an account and a password authenticated to access the file transfer protocol server 12 may read the photographic electronic document without difficulty. Under this circumstance, the contents of the photographic electronic document are revealed without being conscious of the company.

In the conventional document management system, since everyone linked to the local area network can use every function of the multifunction peripheral 11, the possibility of revealing the company's secrets is increased. Moreover, it is difficult to know whom the electronic document is revealed by. In other words, the conventional document management system is ineffective for protecting the important documents.

Therefore, there is a need of developing an office machine having an identity verification unit and a document management system including such an office machine for obviating the drawbacks encountered by the prior art.

### SUMMARY OF THE INVENTION

It is an object of the present invention to provide an office machine having an identity verification unit and a document management system including such an office machine. The document management system can verify the identity and authenticate the electronic signature contained in the electronic document. In addition, an electronic signature is attached to the electronic document when the operations of the office machine are performed. As a consequence, the objects of protecting important secret electronic documents and managing the office machine are achieved, thereby obviating the drawbacks encountered by the prior art.

In accordance with an aspect of the present invention, there is provided an office machine. The office machine includes a processor and an identity verification unit. The processor is used for controlling operations of the office machine. The identity verification unit is included in the processor for verifying identity information of a user when an electronic document sent from the user is received by the office machine. The electronic document is verified according to an asymmetric cryptosystem, thereby ensuring security and user authenticity of the electronic document.

In accordance with another aspect of the present invention, there is provided a document management system. The document management system includes at least a host computer and an office machine. The host computer is communicated to a network. The office machine is communicated to the network and includes a processor. The processor has an identity verification unit for verifying identity information of a user of the host computer when an electronic document sent from the user is received by the office machine. The electronic document is verified according to an asymmetric cryptosystem, thereby ensuring security and user authenticity of the electronic document.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic architecture of a conventional document management system for use with an office machine;

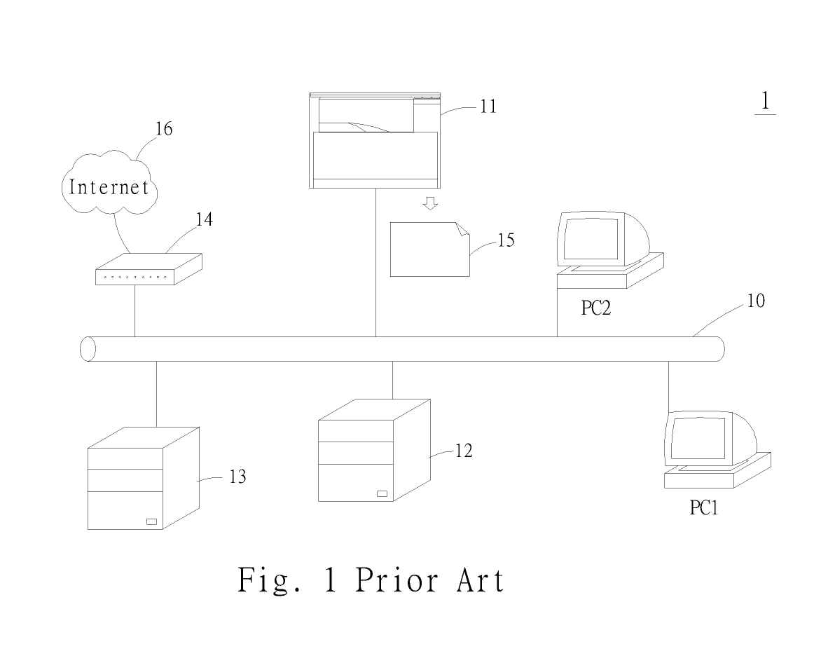

FIG. 2 is a schematic architecture of an office machine having an identity verification unit according to a preferred embodiment of the present invention;

FIG. 3 is a schematic architecture of a document management system for use with the office machine of the present invention;

FIG. 4 is a schematic diagram illustrating an embodiment of attaching an electronic signature to the electronic document by the processor; and

FIG. 5 is a flowchart illustrating operations of an office machine having an identity verification unit.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

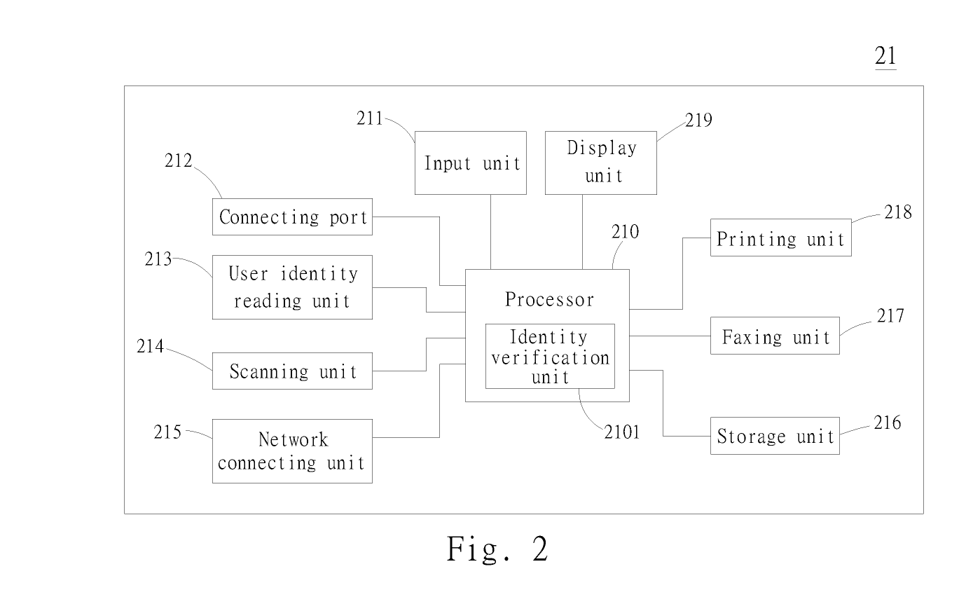

Referring to FIG. 2, a schematic architecture of an office machine having an identity verification unit according to a preferred embodiment of the present invention is illustrated. As shown in FIG. 2, the office machine 21 principally includes an input unit 211, a connecting port 212, a user identity reading unit 213, a scanning unit 214, a network connecting unit 215, a storage unit 216, a faxing unit 217, a printing unit 218 and a display unit 219, which are all communicated with a processor 210.

An identity verification unit 2101 is included in the processor 210. When an electronic document sent from the user is received by the office machine 21, the identity verification unit 2101 may verify identity information of a user. Moreover, an asymmetric cryptosystem such as RSA (Rivest Shamir Adleman) or ElGamal cryptosystem is used to verify the electronic signature contained in the electronic document, thereby ensuring security and user authenticity of the electronic document.

The input unit 211 may include function keys or numeral keys, which are operated to input settings or choose desired functions of the office machine 21.

Via the connecting port 212, the office machine 21 may be communicated with an external portable storage device such as a USB flash disk or a portable hard disk such that electronic documents may be transmitted from the external portable storage device to the connecting port 212. In some embodiments, the connecting port 212 includes but is not limited to a USB connecting port, a mini-USB connecting port or an IEEE 1394 connecting port.

The user identity reading unit 213 is used for reading the identity information of a use. An exemplary user identity reading unit 213 includes but is not limited to a card reader, a retinal blood vessel profile reader, a voice pattern reader or a fingerprint reader. The smart card, the authentication IC or the natural person certificate associated with the user's identity information or the user's voice pattern or fingerprint may be inputted via the user identity reading unit 213. Alternatively, the user identity reading unit 213 may further implement the function of identity verification.

Through the network connecting unit 215, the office machine 21 may be communicated with the local area network or the Internet in a wired or wireless transmission manner. Once the office machine 21 and other electronic device (e.g. a host computer) are linked to the local area network or the Internet through the network connecting unit 215, the electronic document may be transmitted from the host computer to the office machine 21.

The scanning unit 214, the faxing unit 217 and the printing unit 218 of the office machine 21 are optionally used to respectively implement scanning, faxing and printing operations. Under this circumstance, the office machine 21 is a multifunction peripheral. In addition, the operating messages such as the number of papers to be printed or the faxing statuses may be shown on the display unit 219.

Hereinafter, a process of authenticating data transmission by the office machine 21 will be illustrated as follows. First of all, the office machine 21 is communicated with the external portable storage device via the connecting port 212 such that an electronic document is transmitted to the office machine 21. Then, the identity information is read by the user identity reading unit 213 and transmitted to the identity verification unit 2101 of the processor 210. By means of the identity verification unit 2101, an asymmetric cryptosystem is used to verify the electronic signature contained in the electronic document in order to ensure security and user authenticity of the electronic document. In a case that the identity information is verified to be correct, the office machine 21 may normally implement the desired operations. Otherwise, if the identity information is verified to be incorrect, the office machine 21 will reject the operation request. Alternatively, the electronic document may be provided by a host computer when the office machine 21 and the host computer are linked to the local area network or the Internet. By the identity verification unit 2101 of the processor 210, the electronic signature contained in the electronic document is verified in order to ensure security and user authenticity of the electronic document.

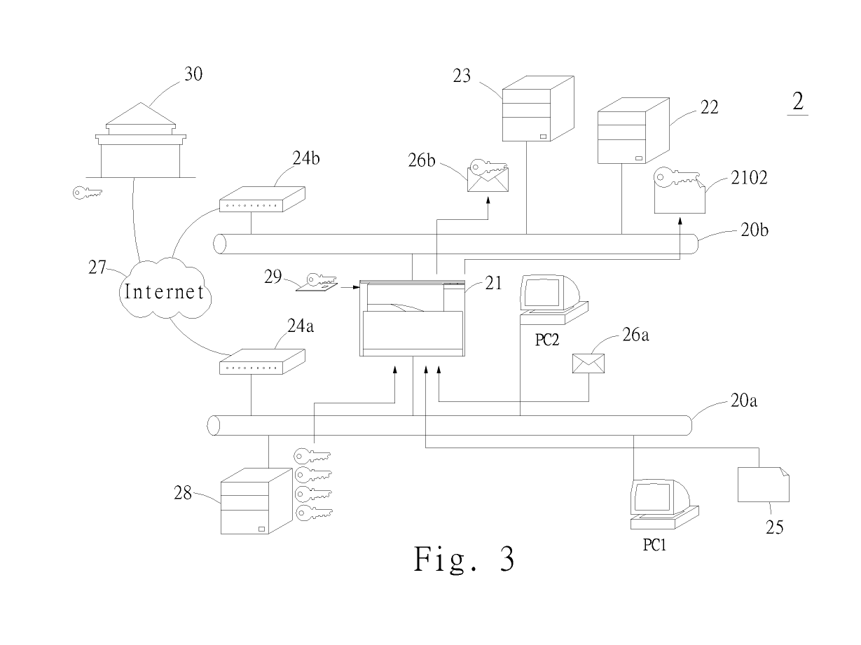

Referring to FIG. 3, a document management system for use with the office machine of the present invention is schematically illustrated. The document management system 2 principally an office machine 21, a file transfer protocol server (Ftp server) 22, an e-mail server 23, two routers 24a and 24b, a lightweight directory access protocol (LDAP) service server 28, a first personal computer PC1 and a second personal computer PC2, which are communicated with each other through local area networks 20a, 20b. The local area networks 20a and 20b are communicated with the Internet 27 through the routers 24a and 24b in a wired or wireless transmission manner. The LDAP service server 28 has stored the company's centralized management data, e.g. e-mail addresses (including the employees, the customers and the firms), phone extension numbers of the staffs, employee numbers, public keys and the like.

For a purpose of using the first personal computer PC1 to print the electronic document 25, the account number and the password associated with a first user are inputted and thus the first personal computer PC1 is communicated with the office machine 21. Meanwhile, the electronic document 25 is transmitted to the office machine 21. Once the electronic document 25 is received by the office machine 21, the identity verification unit 2101 of the processor 210 will verify identity information of the user. Then, the electronic signature contained in the electronic document 25 is verified to authenticate the user. If the identity verification unit 2101 verifies that the electronic signature is valid, the electronic document 25 will be printed out. Whereas, if the identity verification unit 2101 verifies that the electronic signature is invalid, the printing operation of the electronic document 25 is rejected. As a consequence, the document security is enhanced and the confidential document will not be revealed.

On the other hand, for using the second personal computer PC2 to send an e-mail 26a to the receivers beyond the company, the account number and the password associated with a second user are inputted and thus the second personal computer PC2 is communicated with the office machine 21. Meanwhile, the e-mail 26a is transmitted to the office machine 21. Once the e-mail 26a is received by the office machine 21, the identity verification unit 2101 of the processor 210 will verify whether the second user is authenticated to send e-mail to the receivers beyond the company. If the second user is authenticated, the processor 210 will generate an electronic signature and attach the electronic signature to the e-mail 26a, thereby resulting in another e-mail 26b containing the electronic signature. The e-mail 26b containing the electronic signature indicates the sender from the company. Meanwhile, the e-mail 26b will be transmitted to the receivers beyond the company through the e-mail server 23.

Moreover, by means of the office machine 21, an original document may be scanned into a photographic electronic document. For sending the photographic electronic document to the receivers beyond the company, the user may insert a natural person certificate IC card 29 into the user identity reading unit 213 of the office machine 21 (as shown in FIG. 2). Once the natural person certificate associated with the user's identity information is received by the office machine 21, the identity verification unit 2101 of the processor 210 will verify whether the user is authenticated to scan the original document or send the scanned photographic electronic document. If the user is authenticated, the processor 210 will generate an electronic signature according to a private key included in the natural person certificate IC card 29. The electronic signature is attached to the photographic electronic document and the e-mail. Afterwards, the photographic electronic document containing the electronic signature will be transmitted to the e-mail address of the receiver. Since the sender of the photographic electronic document can be realized by checking the electronic signature, the effectiveness of document management is enhanced.

In some embodiments, the photographic electronic document 2102 containing the electronic signature may be transmitted from the office machine 21 to the file transfer protocol server 22. Likewise, an account number and a password associated with the office machine 21 are inputted and thus the office machine 21 is communicated with the file transfer protocol server 22. As a consequence, the user who scans the original document into the photographic electronic document may be realized. In some embodiments, an asymmetric cryptosystem such as RSA (Rivest Shamir Adleman) or ElGamal cryptosystem is used to verify the user's identity information and the electronic signature contained in the electronic document, thereby ensuring security and user authenticity of the electronic document. Alternatively, the retinal blood vessel profile, the user's voice pattern or fingerprint may be verified to ensure security and user authenticity of the electronic document.

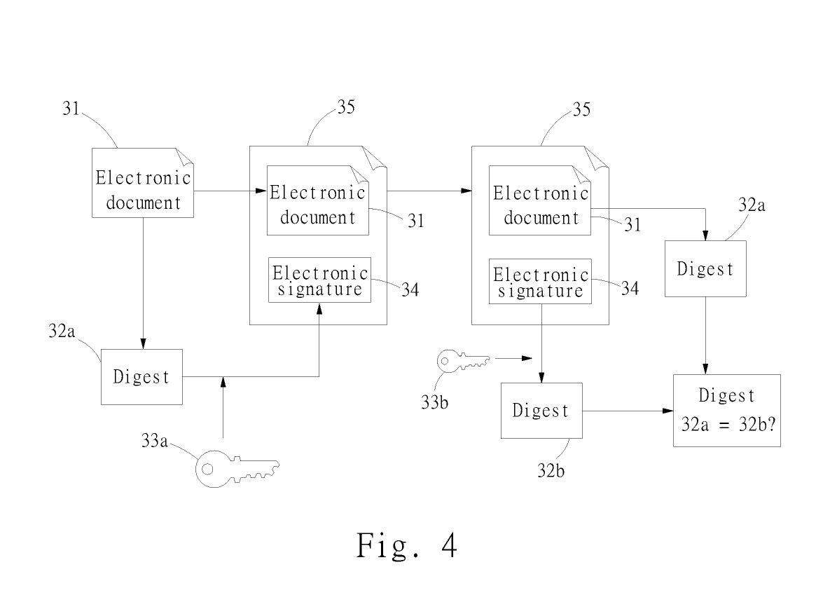

FIG. 4 is a schematic diagram illustrating an embodiment of attaching an electronic signature to the electronic document by the processor. For attaching an electronic signature to the electronic document 31, the processor 210 (as shown in FIG. 2) may calculate a hash value by using a hash function, thereby obtaining a digest 32a of the electronic document 31. Next, the digest 32a of the electronic document 31 is encoded into an electronic signature 34 of a first user according to a private key 33a of the first user. Consequently, the electronic document 31 and the electronic signature 34 of the first user are combined as an electronic signature-containing electronic document 35. When other user receives the electronic signature-containing electronic document 35, the digest 32a of the electronic document 31 contained therein is calculated by using the hash function. In addition, the electronic signature 34 of the electronic signature-containing electronic document 35 is decoded into a possible digest 32b by using a public key 33b of the first user. If the digest 32b is identical to the digest 32a, the electronic document 31 of the electronic signature-containing electronic document 35 is indeed signed by the first user. In other words, before the identity verification unit 2101 of the processor 210 (as shown in FIG. 2) verify the identity information, the public key of the user needs to be obtained. Please refer to FIG. 3 again. The public key of the user may be retrieved from a certificate authority (CA) 30. Moreover, some public keys may have been stored in the LDAP service server 28 in order to increase the speed of retrieving the public key of the user. In some embodiments, the public key of the user is firstly searched from the LDAP service server 28 and then retrieved from a certificate authority 30.

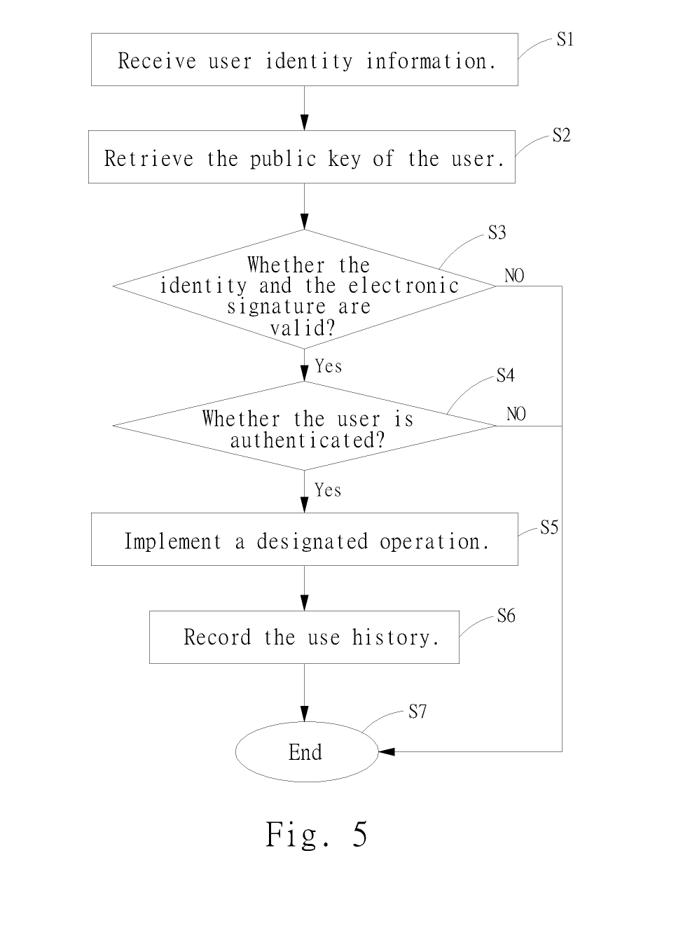

FIG. 5 is a flowchart illustrating operations of an office machine having an identity verification unit. Please refer to FIG. 5 and also FIG. 3. First of all, user identity information is received by the office machine (Step S1). The user identity information may be transmitted to the office machine 21 through local area networks 20a, 20b. Alternatively, an authentication IC associated with the user's identity information may be read from the user identity reading unit 213 of the office machine 21. Next, the public key of the user is retrieved from the LDAP service server 28 or certificate authority 30 (Step S2). Next, the public key of the user is utilized to verify the user's identity information and the electronic signature included in the electronic document (Step S3). Once the verifying result is valid, it is then verified if the user is authenticated to implement the operation of the office machine 21, for example send the photographic electronic document to other receivers by e-mail or print electronic document (Step S4). Once the verifying result is valid, the designated operation such as a printing, faxing or scanning operation is implemented (Step S5). Moreover, the use history is recorded such that the supervisor may realize the operating history of the office machine 21 (Step S6). Finally, the operation process is finished (Step S7).

From the above description, since the processor of the office machine provided by the present invention has an identity verification unit, the user identity and the electronic signature can be verified when an electronic document is received by the office machine, thereby discriminating whether the user is authenticated to operate the office machine. Optionally, the electronic signature may be attached to the electronic document to indicate that the electronic document has been verified. By integrating the office machine of the present invention into the document management system, the user who is linked to the local area network or the Internet is authenticated before operating the office machine. As a consequence, the confidential electronic document fails to be transmitted to the receivers beyond the company by e-mail or facsimile. In addition, the authenticated user fails to print out the confidential electronic document. On the other hand, the user identification information may be provided through the user identity reading unit of the office machine even if the user is not linked to the local area network or the Internet. Therefore, the security of operating the office machine is enhanced. Moreover, since the use history is recorded in the storage unit of the office document, the operating statuses of the electronic document can be tracked. In other words, the office machine and the document management system of the present invention have enhanced security and reliability, thereby obviating the drawbacks encountered by the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An office machine comprising:
a processor for controlling operations of said office machine; and
an identity verification unit included in said processor for verifying identity information of a user when an electronic document sent from said user is received by said office machine, wherein said electronic document is verified according to an asymmetric cryptosystem, thereby ensuring security and user authenticity of said electronic document.

2. The office machine according to claim 1 wherein said electronic document has been attached thereto an electronic signature.

3. The office machine according to claim 1 wherein said office machine further includes a network connecting unit and said office machine is communicated with a network via said network connecting unit.

4. The office machine according to claim 3 wherein said office machine is communicated with a host computer through said network.

5. The office machine according to claim 3 wherein said office machine is communicated with said network via said network connecting unit in a wired or wireless transmission manner.

6. The office machine according to claim 1 wherein said office machine further includes a connecting port and said office machine is communicated with an external portable storage device via said connecting port, thereby transmitting said electronic documents from said external portable storage device to said office machine.

7. The office machine according to claim 6 wherein said external portable storage device is a USB flash disk or a portable hard disk, and said connecting port is a USB connecting port.

8. The office machine according to claim 1 wherein said office machine further includes a user identity reading unit, which is communicated with said processor, for reading said identity information of said user.

9. The office machine according to claim 8 wherein said user identity reading unit is one selected from a group consisting of a card reader, a retinal blood vessel profile reader, a voice pattern reader and a fingerprint reader.

10. The office machine according to claim 1 wherein said office machine is a multifunction peripheral.

11. The office machine according to claim 1 wherein said office machine further includes a printing unit, which is communicated with said processor, for printing said electronic document.

12. The office machine according to claim 1 wherein said office machine further includes a scanning unit, which is communicated with said processor, for scanning an original document.

13. The office machine according to claim 1 wherein said office machine further includes a storage unit, which is communicated with said processor, for storing said electronic document and basic information of said office machine.

14. The office machine according to claim 1 wherein said office machine further includes an input unit, which is communicated with said processor, for inputting settings or choosing desired functions of said office machine therevia.

15. The office machine according to claim 1 wherein said office machine further includes a faxing unit, which is communicated with said processor, for faxing said electronic document.

16. The office machine according to claim 15 wherein an electronic signature is attached onto said electronic document by said processor when a faxing operation of said faxing unit is performed.

17. The office machine according to claim 1 wherein said office machine further includes a display unit, which is communicated with said processor, for displaying operating statues of said office machine.

18. A document management system comprising:
at least a host computer communicated to a network; and
an office machine communicated to said network and including a processor, said processor having an identity verification unit for verifying identity information of a user of said host computer when an electronic document sent from said user is received by said office machine, wherein said electronic document is verified according to an asymmetric cryptosystem, thereby ensuring security and user authenticity of said electronic document.

19. The document management system according to claim 18 further including an e-mail server, which is liked to said network, for sending said electronic document over said network by e-mail.

20. The document management system according to claim 18 further including a lightweight directory access protocol (LDAP) service server, which is liked to said network, for storing therein a public key.
